(19) United States
(12) Patent Application Publication
(10) Pub. No.: US 2007/0032627 A1
(43) Pub. Date: Feb. 8, 2007

(54) Repellent materials

(76) Inventors: Malcolm B. Burleigh, St. Paul, MN (US); James G. Carlson, St. Paul, MN (US); Aran J. Beckham, Hudson, WI (US)

Correspondence Address: 3M INNOVATIVE PROPERTIES COMPANY, PO BOX 33427, ST. PAUL, MN, 55133-3427, US

(21) Appl. No.: 11/498,508

(22) Filed: Aug. 3, 2006

Related U.S. Application Data
(60) Provisional application No. 60/705,865, filed on Aug. 5, 2005.

(51) Int. Cl. C08G 18/10

(52) U.S. Cl. 528/60

(57) ABSTRACT

Urethane compositions comprising (a) a first fluorochemical urethane polymer or oligomer comprising the reaction product of (1) one or more polyisocyanates and (2) one or more fluoroalcohols, and optionally (3) one or more other isocyanate-reactive materials, wherein the ratio of isocyanate to isocyanate-reactive groups is about 1 or less, i.e., Part A, and (b) a second urethane polymer or oligomer comprising the reaction product of (1) one or more diisocyanates, and (2) water, and optionally (3) one or more other isocyanate-reactive groups, wherein about 5 to about 95 mole percent of the isocyanate groups of the diisocyanate are reacted with the water, i.e., Part B, for imparting durable repellency to substrates.

### CROSS REFERENCE TO RELATED APPLICATION

This application claims priority to U.S. Application Ser. No. 60/705,865 filed on Aug. 5, 2005, which is incorporated by reference in its entirety.

### FIELD

This invention relates to urethane emulsions for application to fibrous substrates, e.g., carpets and fabrics, to impart repellency thereto and which exhibit improved durability to steam cleaning, i.e., substrates to which they are properly applied may withstand multiple steam cleaning treatments while retaining surprising levels of their initial repellent performance.

### BACKGROUND

It is known to apply fluorochemical emulsions to fibrous substrates to impart repellency thereto. PM 1396 Protective Treatment from 3M Company is one example of such a commercial product.

The treatments are applied to substrates through a number of processes. One common approach is so-called “exhaustion” in which the repellent material is deposited onto the surface of the substrate from an emulsion yielding a random distribution of particles across the surface of the substrate material. In some cases a stain blocker material is simultaneously deposited onto the substrate in processes referred to as co-exhaustion.

Despite providing, in some instances, good initial repellency, a problem with such fluorochemical emulsions is that the repellent properties they impart to a substrate, e.g., carpet, are degraded significantly after steam cleaning.

A need exists for protective treatments that impart good initial repellency properties and retain good repellency properties after steam cleaning.

### BRIEF SUMMARY

It has been discovered that treatments comprising novel blends of certain urethane polymers with repellent materials impart durable repellency to substrates to which the treatments have been properly applied. Substrates to which such treatments are properly applied may withstand multiple steam cleaning treatments while retaining surprising levels of their initial repellent performance.

Repellent treatments of the invention comprise two parts, referred to herein as Part A and Part B. Parts A and B may be formed into a single emulsion particle or the treatment may comprise a blend of compositionally distinct emulsion particles of Part A and Part B.

In brief summary, compositions of the invention comprise (a) a first fluorochemical urethane polymer or oligomer comprising the reaction product of (1) one or more polyisocyanates and (2) one or more fluoroalcohols, and optionally (3) one or more other isocyanate-reactive materials, wherein the ratio of isocyanate groups to isocyanate-reactive groups is about 1 or less, i.e., Part A, and (b) a second urethane polymer or oligomer comprising the reaction product of (1) one or more diisocyanates, and (2) water, and optionally (3) one or more isocyanate-reactive materials wherein about 5 to 95 mole percent of the isocyanate groups of the diisocyanate are reacted with the water, i.e., Part B.

Repellent treatments of the invention may be used on a variety of fibrous substrates including, for example, carpets and fabrics made from a variety of materials, e.g., nylon, polyamide, polyimides, polyolefins, wool, etc.

### DETAILED DESCRIPTION OF ILLUSTRATIVE EMBODIMENTS

Part A

Part A may be made in several ways and its nature preferably has a high fluorine content and a melting point below the temperature that fiber sees in its processing steps. These types of materials are well known in the art and impart very high initial repellencies.

Some illustrative examples of materials that can be used as Part A include fluorochemical urethanes such as 3M™ Protective Chemical PM-1396, an anionic fluorochemical emulsion used in exhaustion co-application treatments. Additionally Dupont™ NRD 372, a commercially available material from Dupont may also be used as Part A.

If desired, the first fluorochemical urethane polymer or oligomer, i.e., Part A, can be made by making the reaction product of (1) one or more polyisocyanates, (2) one or more fluoroalcohols, and optionally (3) one or more isocyanate-reactive materials, wherein the ratio of isocyanate groups to isocyanate-reactive groups is about 1 or less.

Part B

The second urethane polymer or oligomer, i.e., Part B, comprises the reaction product of (1) one or more diisocyanates, (2) water, and optionally (3) one or more isocyanate-reactive materials wherein about 5 to 95 mole percent of the isocyanate groups of the diisocyanate are reacted with the water. Part B is a material made by reacting diisocyanates with isocyanate-reactive materials but allowing a substantial amount of isocyanate to remain at the end of the reaction. This material is then emulsified, either in conjunction with Part A or by itself. We have been surprised to find that a substantial amount of the original isocyanate content of the Part B remains after the emulsification. The isocyanate then reacts to form a polyurethane-urea.

Polyisocyanates

Polyisocyanates useful in the present invention include those having the formula:
Z-[NCO]ₙ
wherein n is 2 or more, i.e., organic compounds having two or more isocyanate groups on a single molecule. This definition includes diisocyanates, triisocyanates, tetraisocyanates, etc. The non-isocyanate portion Z of the polyisocyanate can be of any chemical nature that provides utility in the invention. Z can be aliphatic, cycloaliphatic, aromatic or combinations thereof. Z may contain heteroatoms including N, S, or O. The polyisocyanate may be a mixture of polyisocyanates.

One preferred polyisocyanate, DESMODUR™ N-3300 available from Bayer Corporation, comprises a triisocyanate where n is 3 and Z comprises an isocyanurate moiety coupled to the NCO moieties by 3 linking groups. In other embodiments the polyisocyanate comprises a biuret group as in the commercial material “DESMODUR™ N-100” sold by Bayer Corp. Another preferred polyisocyanate is isophorone diisocyanate available commercially as DEMODUR™ I from Bayer.

Examples of useful polyisocyanates include 2,4-tolylenediisocyanate, 4,4′-diphenylmethanediisocyanate, 2,4′-diphenylmethanediisocyanate, tolidinediisocyanate, 2-methyl-cyclohexane 1,4-diisocyanate, benzene 1,4-diisocyanate(p-phenylenediisocyanate), naphthalene 1,5-diisocyanate, polymeric diphenylmethane diisocyanate, trimerized aromatic or aliphatic diisocyanates, 2,2,4-trimethyl hexane 1,6-diisocyanate, VESTANAT™ TMDI (comprising 2,2,4-trimethyl hexane 1,6-diisocyanate and 2,4,4-trimethylhexane 1,6-diisocyanate), 2-methyl-cycohexane 1,4-diisocyanate, isophoronediisocyanate (IPDI), and hydrogenated 4,4-diphenylmethane diisocyanate (DESMODUR™ W, H12MDI), hexamethylenediisocyanate (HDI), cyclohexane 1,4-diisocyanate (CHDI), decamethylenediisocyanate, and xylylenediisocyanate.

Fluoroalcohol

The fluoroalcohol preferably comprises from 4 to 12 carbon atoms which have at least one fluorine atom bonded thereto. More preferably, the fluoroalcohol has a perfluorinated segment that contains from 4 to 12 carbon atoms.

Representative fluoroaliphatic alcohols that can be used in the present invention include those having the formula:
C_{n′}F_{2n′+1}(CH₂)_{m′}OH
where n′ is 3 to 14 and m′ is 1 to 12;
(CF₃)₂CFO(CF₂CF₂)_{p′}CH₂CH₂OH
where p′ is 1 to 5;
C_{n′}F_{2n′+1}CON(R³)(CH₂)_{m′}OH
where R³ is H or lower alkyl, n′ is 3 to 14, m′ is 1 to 12;
C_{n′}F_{2n′+1}SO₂N(R³)(CH₂)_{m′}OH
where R³, n′, and m′ are described above; and
C_{n′}F_{2n′+1}SO₂NR³(CH₂)_{m′}((OCH₂C(H)(CH₂Cl))_{r′}OH
where R³, n′, m′ are described above, and r′ is 1 to 5.

Isocyanate-Reactive Materials

The above-described polyisocyanates can be reacted with co-reactants comprising one or more isocyanate-reactive groups. Isocyanate-reactive groups have a general structure -Z-H, wherein Z is selected from the group consisting of O, N, and S. Preferably, Z is O or N.

Suitable isocyanate-reactive materials include, for example, polyols, polyamines, and polythiols. As used herein, the prefix “poly” means one or more. For example, the term “polyols” includes monohydric alcohols diols, triols, tetraols, etc.

Polyols

A preferred class of isocyanate reactive materials is polyols. The term “polyol” as used herein refers to mono or polyhydric alcohols containing an average of one or more hydroxyl groups and includes, for example, monohydric alcohols, diols, triols, tetraols, etc.

A preferred class of polyols is diols. A variety of diols may be utilized according to the invention including both low molecular weight and oligomeric diols. Also, mixtures of diols can be used.

Low molecular weight (less than about 500 number average molecular weight) diols may be used. Some representative examples of these are ethylene glycol; propylene glycol; 1,3-propane diol; 1,4-butane diol; 1,5-pentane diol; 1,6-hexane diol, neopentyl glycol; diethylene glycol; dipropylene glycol; 2,2,4-trimethyl-1,3-pentane diol; 1,4-cyclohexanedimethanol; ethylene oxide and/or propylene oxide adduct of bisphenol A; and ethylene oxide and/or propylene oxide adduct of hydrogenated bisphenol A. It is further noted that for any of the reactants mentioned, mixtures of materials can be utilized.

A preferred class of polyols is oligomeric polyols defined as polyols having a number average molecular weight between about 500 and about 5000. Preferred members of this class are polyester diols, polyether diols and polycarbonate diols having a hydroxyl equivalent weight of from about 250 to about 3,000 (g/eq). Such materials include polyester (polycaprolactone) diols such as TONE™ 0210, available from Dow Chemical Company, having a hydroxyl equivalent weight of about 415. Another such material is RAVECARB™ 106, a polycarbonate diol from Tri-Iso, Inc. having a number average molecular weight of about 2000 (polyhexanediol carbonate).

Other useful oligomeric polyols include but are not limited to those selected from the group consisting of: polyether diols such as polytetramethylene glycols and polypropylene glycols; polyester diols such as a polyester diol that is the reaction product of a mixture of adipic and isophthalic acids and hexane diol; polyether triols; and polyester triols. It is further noted that for any of the reactants mentioned, mixtures of materials can be utilized.

Preferred polyols include polypropylene glycol such as ARCOL™ PPG 2025 having a number average molecular weight of about 2000 from Bayer Corporation and polyethylene glycols sold under the tradename CARBOWAX by Dow Chemical Co.

Polyamines

Useful polyamines include, for example, polyamines having at least two amino groups, wherein the two amino groups are primary, secondary, or a combination thereof. Examples include 1,10-diaminodecane, 1,12-diaminododecane, 9,9-bis(3-aminopropyl)fluorene, bis(3-aminopropyl)phenylphosphine, 2-(4-aminophenyl)ethylamine, 1,4-butanediol bis(3-aminopropyl) ether, N(CH₂CH₂NH₂)₃, 1,8-diamino-p-menthane, 4,4′-diaminodicyclohexylmethane, 1,3-bis(3-aminopropyl)tetramethyldisiloxane, 1,8-diamino-3,6-dioxaoctane, 1,3-bis(aminomethyl)cyclohexane, 1,4-bis(3-aminopropyl)piperazine, and polymeric polyamines such as linear or branched (including dendrimers) homopolymers and copolymers of ethyleneimine (that is, aziridine), aminopropylmethylsiloxane-co-dimethylsiloxane, bis-aminopropyldimethylsiloxane, and the like.

Polythiols

Examples of polythiols include 2,2′-oxydiethanethiol, 1,2-ethanethiol, 3,7-dithia-1,9-nonanedithiol, 1,4-butanedithiol, 1,6-hexanedithiol, 1,7-heptanedithiol, 1,8-octanedithiol, 1,9-nonanedithiol, 3,6-dioxa-1,8-octanedithiol, 1,10-decanedithiol, 1,12-dimercaptododecane, ethylene glycol bis(3-mercaptopropionate), 1,4-butanediol bis(3-mercaptopropionate), and the like.

Application to Substrates

The nature of the fixing process by which repellent materials are deposited onto the substrate can be varied and is present in the art in varied forms. There are several processes that will fix or deposit the material onto a desired substrate, e.g., fabric or carpet. Emulsions formed from cationic surfactants tend to fix readily onto a fiber.

On the other hand anionic emulsions do not have this tendency. With nylon carpet it is necessary to use anionic emulsifiers since polyanionic stainblockers will be rendered ineffective by cationic emulsifiers applied after the stainblockers. In order to exhaust the materials onto the carpet, high aqueous temperatures (about 100° C.), low pH, and optionally the use of polycationic salts such as magnesium are employed.

It has been found that many types of isocyanate molecules can remain in contact with water for extended periods of time, long enough to prepare solvent based emulsions with them as the major portion of the emulsion particle. Once the emulsion is formed the isocyanate is allowed to react with the ambient water to form a polyurethaneurea. The isocyanates may either be aliphatic or aromatic. Aromatic isocyanates react faster with water but the only issue with them is that there is less time to form the emulsion. Prior to the water reaction the isocyanate may be optionally reacted with various isocyanate-reactive materials. The reaction product preferably retains solubility in the organic solvent.

In some embodiments, the ratio of A to B ranges from about 10/90 to 90/10. In some embodiments, the ratio of A to B ranges from about 25/75 to 75/25. In some instances, the blend will be an emulsion in water of particles having an average particle size of less than about 0.5 microns (μ).

In many embodiments, the composition of Part A and Part B, which may be a simple blend of emulsions or may be an emulsion prepared by mixing Part A and Part B urethanes and preparing that emulsion, will be applied to the substrate such as by spraying, dipping, or other known means, and then dried to yield the desired durably repellent finish thereon. In some instances, Part A and Part B may be applied to the substrate separately.

In some embodiments, the invention will be in the form of a method of making a fluorochemical polymer or oligomer comprising urea groups wherein the majority of the urea groups are formed within particles of an aqueous dispersion having an average particle size of less than about 0.5 microns.

In some embodiments, the urea groups are derived from the reaction product of an isocyanate-functional precursor with water after dispersing the precursor in water wherein the isocyanate-functional precursor comprises the reaction product of one or more polyisocyanates, one or more fluorochemical alcohols, optionally other isocyanate-reactive materials such that the fluoroalcohols, and other isocyanate-reactive materials consume no more than about 40% of the isocyanate groups on the polyisocyanate. The isocyanate-functional precursor may contain an organic solvent such as methylisobutyl ketone (MIBK) or ethylacetate. The fluorochemical polymer containing urea groups may be formed within the aqueous dispersion while the solvent is still present. The polymer containing urea groups may be formed after the solvent is distilled. The solvent may be subsequently removed leaving a substantially solvent free fluorochemical emulsion.

### EXAMPLES

The invention will be further explained with the following non-limiting examples.

The following materials were used in the examples.

TABLE 1

| Designation | Material | Availability/Preparation |
|---|---|---|
| DBTDL | Dibutyltin dilaurate; | Sigma-Aldrich, Milwaukee, WI |
| | [CH₃(CH₂)₃]₂Sn[OOC(CH₂)₁₀CH₃]₂ | |
| Dowfax 8390 | Alkyldiphenyloxide disulfonate anionic | Dow, Midland, MI |
| | type surfactant (35% active in water) | |
| IPDI | DESMODUR ® I; | Bayer, Pittsburgh, PA |
| | isophorone diisocyanate | |
| MA2300 | Mondur ® MA-2300 | Bayer |
| | diphenylmethane 4,4′-diisocyanate | |
| | (MDI) | |
| MeFBSE | N-methylperfluorobutanesulfonyl | Made by reacting |
| | ethanol; C₄F₉SO₂N(CH₃)CH₂CH₂OH | perfluorobutanesulfonyl fluoride |
| | | with CH₃NH₂ and ethylene |
| | | chlorohydrin, essentially as |
| | | described in Example 1 of U.S. |
| | | Pat. No. 2,803,656 |
| | | (Ahlbrecht, et al.) |
| MIBK | Methylisobutyl ketone; | Sigma-Aldrich |
| | (CH₃)₂CHCH₂C(O)CH₃ | |
| MPEG 750 | CARBOWAX ™ 750; | Dow, Midland, MI |
| | Methoxypolyethylene glycol (MWₐᵥ = 750) | |
| N3300A | DESMODUR ® N-3300A; eq wt = 194 | Bayer |
| | Polyfunctional isocyanate resin based on | |
| | hexamethylene diisocyanate | |
| PM 1396 | Fluorochemical urethane | 3M Company, St. Paul, MN |
| | MeFBSE/N3300A/SA | |
| PPG2025 | Arcol ® PPG-2025 polyether polyol; | |
| | 2000 molecular weight diol based on | |
| | propylene glycol | |
| SA | Stearyl alcohol; CH₃(CH₂)₁₆CH₂OH | Sigma-Aldrich |
| (Telomer alcohol | Telomer alcohol comprised primarily of | Hoechst |
| “A”) | C8 and C10 telomer alcohols having an | |
| | equivalent weight of 505 | |
| (Telomer alcohol | Fluowet ® EA600 having an equivalent | Clariant Corporation |
| “B”) | weight of 308 | |

Test Methods

Water Repellency Test

Treated carpet samples were evaluated for water repellency (WR) using 3M Water Repellency Test II: Water/alcohol Drop Test (Document #98-0212-0721-6; available from 3M) In this test, carpet samples to be evaluated are challenged to penetrations by blends of DI water and isopropyl alcohol (IPA). Each blend is assigned a rating number as shown in Table 2. In running the Water Repellency Test, a treated carpet sample is placed on a flat, horizontal surface and the carpet pile is hand-brushed in the direction giving greatest lay to the yarn. Five small drops of water, IPA or water/IPA mixture are gently placed at points at least two inches (5.0 cm) apart on the carpet sample. If, after observing for ten seconds at a 45° angle, four of the five drops are visible as a sphere or hemisphere, the carpet is deemed to pass the test. The reported water repellency rating corresponds to the highest numbered water, IPA or water/IPA mixture for which the treated sample passes the described test.

TABLE 2

| Water Repellency | |
|---|---|
| Rating Number | Water/IPA Blend (% by volume) |
| F | Fails water |
| 0 | 100% water |
| 1 | 90/10 |
| 2 | 80/20 |
| 3 | 70/30 |
| 4 | 60/40 |
| 5 | 50/50 |
| 6 | 40/60 |
| 7 | 30/70 |
| 8 | 20/80 |
| 9 | 10/90 |
| 10 | 100% IPA |

Oil Repellency Test

Carpet samples were evaluated for oil repellency (OR) using 3M Oil Repellency Test III (February 1994 Document #98-0212-0713-3; available from 3M) In this test, carpet samples are challenged to penetration by oil or oil mixtures of varying surface tensions. Oils and oil mixtures are given ratings described in Table 3. The oil repellency test is run in the same manner as the water repellency test listed above, with the reported oil repellency corresponding to the highest oil or oil mixture for which the treated carpet sample passes the test.

TABLE 3

| Oil Repellency | |
|---|---|
| Rating Number | Oil Composition |
| F | Fails mineral oil |
| 1 | Mineral oil |
| 1.5 | 85/15 mineral oil/n-hexadecane (% vol) |
| 2 | 65/35 mineral oil/n-hexadecane (% vol) |
| 3 | n-hexadecane |
| 4 | n-tetradecane |
| 5 | n-dodecane |
| 6 | n-decane |

Simulated Flex-Nip Application Procedure

The simulated Flex-Nip described below was used to simulate the flex-nip operation used by carpet mills to apply stain-blocking compositions to carpet.

In this test, a carpet sample measuring approximately 13 cm×10 cm is immersed in DI water at room temperature until dripping wet. Water is extracted from the wet sample by spinning in a Bock Centrifugal Extractor until the sample is damp. The damp sample is the steamed form 2 minutes at atmospheric pressure, at a temperature of 90° C. to 100° C., and 100% relative humidity in an enclosed steam chamber.

After steaming the carpet sample is allowed to cool to near room temperature, and the aqueous treating composition is applied by placing the carpet sample, carpet fiber side down, in a glass tray containing the treating composition. The treating composition contains sufficient glassy fluorochemical and/or hydrocarbon material and sufficient stain-blocking material to give the desired percent solids on fiber (% SOF) and is prepared by dissolving or dispersing the two types of materials and optionally the desired amount of salt in DI water and adjusting the pH to a value of 2 (unless otherwise specified) using 10% aqueous sulfamic acid. The weight of the aqueous treating solution in the glass tray is approximately 3.5 to 4.0 times the weight of the carpet sample. The carpet sample absorbs the entire volume of treating solution over a 1 to 2 minute period to give a percent wet pick-up of about 350 to 400%.

Then the wet, treated carpet sample is steamed a second time for two minutes (using the same equipment and conditions as described above), immersed briefly in a 5-gallon (20 liter) pail half full of DI water, rinsed thoroughly under a DI water stream to remove residual, excess treatment composition, spun to dampness using the centrifugal extractor, and allowed to air-dry overnight at room temperature before testing.

Steam Cleaning (SC) Procedure

The following procedure is used to evaluate the cleaning effectiveness and durability of carpet treatments or for other circumstances requiring consistent cleaning of carpets.

Carpet samples were firmly secured to a piece of wood with the dimensions of 30 cm×30 cm with a thickness of 1 cm.

A board cleaning machine was used to minimize the variability that is inherently associated with technique and operator differences in manually operated carpet and steam cleaners. The machine cleans each board of carpet samples in three steps with shampooing in the first step and rinsing in the subsequent two steps.

The cleaning machine has three stations with a spray nozzle and vacuum cleaner head at each one. The first station sprays soap solution on the carpet samples immediately preceding a vacuum head that moves slowly over the surface of the carpet. The next two stations spray only hot water for rinsing immediately in front of the vacuum head as it passes over the carpet, removing as much water as possible. A turntable carries the boards with the carpet samples to each station, resulting in a 90° turn of the samples at each station.

A metering pump delivers the soap solution from a reservoir into the water line connected to the first head. A hot water heater supplies all of the water at a temperature of 65° C. The soap solution was made from 1.0 kilogram of Bane-Clene P.C.A. Formula 5 (Powdered Cleaning Agent) dissolved in 250 liters of water.

### Example 1

Part A: A 2 liter 3-neck round bottom flask equipped with a magnetic stirrer was charged with 0.319 equivalents (eq.) MeFBSE (113.9 grams), MIBK (250.0 grams), 0.003 eq. SA (0.875 grams) and 0.258 eq. N3300A (49.8 grams). To this was added DBTDL catalyst (100 milligrams). The temperature of the stirred mixture was maintained at 80° C. for 2 hours.

Part B: 0.418 eq. IPDI (46.5 grams) and 0.039 eq. PPG2025 (38.9 grams) were added to the above reaction mixture and the reaction mixture was maintained at 80° C. for an additional 2 hours to add Part B.

Emulsion preparation: The resultant product and additional MIBK (95 grams) were mixed and then added to a mixture of water (814 grams) and Dowfax® 8390 (35.7 grams). The material was run three passes through a Gaulin Corporation, Model 15M-8TA Lab Homogenizer & Sub-micron Disperser at 3500 psi. This material was then left at 65° C. for 16 hours under mild agitation and then stripped of its solvent at 65° C. under vacuum. The sample was analyzed on a Horiba LA-910 laser scattering particle size distribution analyzer and found to have a mean particle size of 0.101 micron.

### Example 2

Part A: A 1 liter 3-neck round bottom flask equipped with a magnetic stirrer was charged with 0.095 equivalents (eq.) MeFBSE (33.8 grams), MIBK (75.0 grams), 0.003 eq. SA (0.75 grams), 0.011 eq. PPG2025 (11.25 grams and 0.048 eq. N3300A (9.3 grams). To this was added DBTDL catalyst (100 milligrams). The temperature of the stirred mixture was maintained at 80° C. for 1 hour.

Part B: 0.18 eq. IPDI (20.0 grams) was added to the above reaction mixture and the reaction mixture was maintained at 80° C. for another hour to add Part B.

Emulsion preparation: The resultant product and additional MIBK (40.0 grams) were mixed and then added to a mixture of water (271 grams) and DOWFAX® 8390 (10.7 grams). Under stirring in a stainless steel beaker the material was allowed to emulsify for 15 minutes using a Branson Sonifier 450, equipped with a 102 converter. This material was then left at 65° C. for 16 hours under mild agitation and then stripped of its solvent at 65° C. under vacuum.

### Example 3

Part A: A 1 liter 3-neck round bottom flask equipped with a magnetic stirrer was charged with 0.125 equivalents (eq.) MeFBSE (44.8 grams), 0.103 eq. N3300A (20.0 grams) and an equal weight of MIBK. To this was added DBTDL catalyst (100 milligrams). The temperature of the stirred mixture was maintained at 80° C. for 1 hour.

Part B: 0.103 eq. MA2300 (18.6 grams), 0.016 eq. PPG2025 (15.6 grams) and an equivalent amount of MIBK were added to the above reaction mixture and the reaction mixture was maintained at 80° C. for another hour to add Part B.

Emulsion preparation: The resultant product and additional MIBK (40.0 grams) were mixed and then added to a mixture of water (400 grams) and DOWFAX® 8390 (14.3 grams). Under stirring in a stainless steel beaker the material was allowed to emulsify for 15 minutes using a Branson Sonifier 450, equipped with a 102 converter. This material was then left at 65° C. for 16 hours under mild agitation and then stripped of its solvent at 65° C. under vacuum.

### Example 4

Part A: PM 1396 (65.0 grams, 100% solids).

Part B: 1 liter 3-neck round bottom flask equipped with a magnetic stirrer was charged with 0.383 eq. IPDI (42.5 grams), 0.057 eq. PPG2025 (57.5 grams), DBTDL catalyst (100 milligrams) and an equivalent amount of MIBK. The temperature of the stirred mixture was maintained at 80° C. for 1 hour.

Emulsion preparation: An emulsion was prepared by combining Part A with 35 grams of Part B with MIBK to make a solution at 42% solids. This was then to a mixture of water (400 grams) and DOWFAX® 8390 (14.3 grams). Under stirring in a stainless steel beaker the material was allowed to emulsify for 15 minutes using a Branson Sonifier 450 equipped with a 102 converter. This material was then left at 65° C. for 16 hours under mild agitation and then stripped of its solvent at 65° C. under vacuum.

### Example 5

Part A: A 1 liter 3-neck round bottom flask equipped with a magnetic stirrer was charged with 0.099 eq. Telomer alcohol “A” (50.2 grams), 0.080 eq. N3300A (15.5 grams), 0.001 eq. SA (0.27 grams) and an equal weight of MIBK. To this was added DBTDL catalyst (100 milligrams). The temperature of the stirred mixture was maintained at 80° C. for 1 hour.

Part B: 0.168 eq. IPDI (18.6 grams), 0.015 eq. PPG2025 (15.5 grams) and an equivalent amount of MIBK were added to the above reaction mixture and the reaction mixture was maintained at 80° C. for another hour to add Part B.

Emulsion preparation: 200 grams of the resultant product and additional MIBK (40.0 grams) were mixed and then added to a mixture of water (400 grams) and DOWFAX® 8390 (14.3 grams). Under stirring in a stainless steel beaker the material was allowed to emulsify for 15 minutes using a Branson Sonifier 450, equipped with a 102 converter. This material was then left at 65° C. for 16 hours under mild agitation and then stripped of its solvent at 65° C. under vacuum.

### Example 6

Part A: A 1 liter 3-neck round bottom flask equipped with a stirrer was charged with 0.124 eq. Telomer alcohol “B” (47.1 grams), 0.100 eq. N3300A (19.3 grams), 0.001 eq. SA (0.34 grams) and an equal weight of MIBK. To this was added DBTDL catalyst (100 milligrams). The temperature of the stirred mixture was maintained at 80° C. for 1 hour.

Part B: 0.163 eq. IPDI (18.1 grams), 0.015 eq. PPG2025 (15.1 grams) and an equivalent amount of MIBK were added to the above reaction mixture and the reaction mixture was maintained at 80° C. for another hour to add Part B.

Emulsion preparation: 200 grams of the resultant product and additional MIBK (40.0 grams) were mixed and then added to a mixture of water (400 grams) and DOWFAX® 8390 (14.3 grams). Under stirring in a stainless steel beaker the material was allowed to emulsify for 15 minutes using a Branson Sonifier 450, equipped with a 102 converter. This material was then left at 65° C. for 16 hours under mild agitation and then stripped of its solvent at 65° C. under vacuum.

Examples 1-6 were applied to carpet samples as described above and were tested for water repellency (initial and after two steam cleanings) according to the above test methods. The data is summarized in Table 4.

TABLE 4

| | |
|---|---|
| Initial (0 | After 2 |
| Steam | Steam |
| Cleanings) | Cleanings |

| Example | WR | OR | WR | OR |
|---|---|---|---|---|
| 1 | 2 | 4 | 2 | 1 |
| 2 | 3 | 4 | 2 | 2 |
| 3 | 3 | 5 | 2 | 2 |
| 4 | 3 | 4 | 2 | 2.5 |
| 5 | 2 | 4 | 1 | 0 |
| 6 | 2 | 4 | 2 | 2 |
| PM 1396 | 2 | 4 | 0 | 0 |
| Control | | | | |

### Examples 7-22

For Examples 7-22, the weight ratios of Part A to Part B were varied over several orders of magnitude. For examples 7-14, Part A and Part B were in the same emulsion and for Examples 15-22, Part A and Part B were prepared as separate emulsions and the emulsions were then blended after they were made. The emulsions were then all applied to carpet samples as described above at a 500 ppm fluorine level based upon the carpet weight.

Part A: A 2 liter 3-neck round bottom flask equipped with a stirrer was charged with 0.410 eq. MeFBSE (146.1 grams), 0.05 eq. SA (14.6 grams), 0.46 eq. N3300A (89.3 grams) and equal weight MIBK. To this was added DBTDL catalyst (150 milligrams). The temperature of the stirred mixture was maintained at 80° C. for 2 hours.

Part B: A 2 liter 3-neck round bottom flask equipped with a stirrer was charged with 0.238 eq. (85 grams) MeFBSE, 0.143 eq. PPG2025 (143 grams), 1.55 eq. IPDI (171.9 grams) and an equivalent amount of MIBK. To this was added DBTDL catalyst (150 milligrams). The temperature of the stirred mixture was maintained at 80° C. for 1 hour.

A series of emulsions were made by using, in each instance, a total of 200 grams of the above described Part A and Part B materials mixed in varying amounts as indicated Table 5 and Table 6, with an additional 40 grams MIBK in each instance, and then the resultant mixture in each instance was added to a mixture of water (400 grams) and DOWFAX® 8390 (14.3 grams). Under stirring in a stainless steel beaker the material was allowed to emulsify for 15 minutes using a Branson Sonifier 450, equipped with a 102 converter. The resultant product material was left at 65° C. for 16 hours under mild agitation and then stripped of its solvent at 65° C. under vacuum.

In Series I (Table 5), the Part A and Part B materials were emulsified together in the indicated weight ratios. In Series II (Table 6) the Part A and Part B materials were first emulsified separately and then the subsequent two emulsions were mixed in the indicated weight percent ratios.

TABLE 5

| Series I - | | | Initial | | | |
|---|---|---|---|---|---|---|
| Emulsified | | | Repellency | | Repellency | |
| together | | | (0 SC) | | after 2 SC | |
| Example | % Part A | % Part B | WR | OR | WR | OR |
| C7 | 0 | 100 | 2 | 2 | 1 | 0 |
| 8 | 90 | 10 | 2 | 4 | 2 | 1.5 |
| 9 | 25 | 75 | 2 | 5 | 2 | 2 |
| 10 | 35 | 65 | 2 | 5 | 2 | 2 |
| 11 | 50 | 50 | 2 | 4 | 2 | 2 |
| 12 | 65 | 35 | 3 | 5 | 2 | 2 |
| 13 | 75 | 25 | 3 | 5 | 2 | 2 |
| 14 | 90 | 10 | 3 | 4 | 2 | 0 |
| PM 1396 control | 100 | 0 | 2 | 3 | 1 | 0 |

TABLE 6

| Series II - | | | | | | |
|---|---|---|---|---|---|---|
| Emulsified | | | Initial | | Repellency | |
| separately, then | | | Repellency | | after 2 | |
| blended | | | (0 SC) | | SC | |
| Example | % Part A | % Part B | WR | OR | WR | OR |
| C15 | 0 | 100 | 2 | 2 | 1 | 0 |
| 16 | 4 | 96 | 3 | 5 | 2 | 0 |
| 17 | 12 | 88 | 3 | 5 | 2 | 1 |
| 18 | 17 | 83 | 3 | 5 | 2 | 1 |
| 19 | 28 | 72 | 3 | 5 | 2 | 1 |
| 20 | 42 | 58 | 3 | 5 | 2 | 1.5 |
| 21 | 54 | 46 | 3 | 5 | 2 | 1.5 |
| 22 | 78 | 22 | 3 | 4 | 2 | 0 |
| PM 1396 control | 100 | 0 | 2 | 3 | 1 | 0 |

Various modifications and alterations of this invention will become apparent to those skilled in the art without departing from the scope and spirit of this invention.

What is claimed is:

1. A composition comprising (a) a first fluorochemical urethane polymer or oligomer comprising the reaction product of (1) one or more polyisocyanates and (2) one or more fluoroalcohols, wherein the ratio of isocyanate groups to isocyanate-reactive groups is about 1 or less, and (b) a second urethane polymer or oligomer comprising the reaction product of (1) one or more diisocyanates, and (2) water wherein about 5 to about 95 mole percent of the isocyanate groups of the diisocyanate are reacted with the water.

2. The composition of claim 1 wherein the ratio of said first polymer or oligomer to said second polymer or oligomer is from about 10/90 to 90/10.

3. The composition of claim 2 wherein the ratio of said first polymer or oligomer to said second polymer or oligomer is from about 25/75 to 75/25.

4. The composition of claim 1 wherein said composition is a blend of two separately prepared emulsions, an emulsion prepared from (a) said first polymer or oligomer and an emulsion prepared from (b) said second polymer or oligomer.

5. The composition of claim 1 wherein said composition is a single emulsion prepared by mixing (a) said first polymer or oligomer and (b) said second polymer or oligomer in organic solvent and subsequently preparing an emulsion.

6. The composition of claim 5 wherein said the average particle size of said emulsion is less than about 0.5μ.

7. The composition of claim 1 wherein said first polymer or oligomer comprises the reaction product of (1) one or more polyisocyanates, (2) one or more fluoroalcohols, and (3) one or more other isocyanate-reactive materials.

8. The composition of claim 1 wherein said first polymer or oligomer comprises the reaction product of (1) one or more polyisocyanates, (2) one or more fluoroalcohols, and (3) one or more polyols.

9. The composition of claim 1 wherein said second polymer or oligomer comprises the reaction product of (1) one or more diisocyanates, (2) water, and (3) one or more, other isocyanate-reactive materials.

10. The composition of claim 1 wherein said second polymer or oligomer comprises the reaction product of (1) one or more diisocyanates, (2) water, and (3) one or more polyols.

11. The composition of claim 1 wherein the range of isocyanate groups in the diisocyanate that are reacted with water in said second polymer or oligomer is from about 60 to about 95 mole percent.

12. A method of making a fluorochemical polymer or oligomer comprising urea groups wherein the majority of the urea groups are formed within particles of an aqueous dispersion having an average particle size of less than about 0.5μ.

13. The method of claim 12 wherein the urea groups are derived from the reaction product of an isocyanate-functional precursor with water after dispersing the precursor in water.

14. A method of treating a substrate to impart repellency properties thereto comprising applying a composition of claim 1 to said substrate and drying.

15. A method of treating a substrate to impart repellency properties thereto comprising applying to a substrate (a) a first fluorochemical urethane polymer or oligomer comprising the reaction product of (1) one or more polyisocyanates and (2) one or more fluoroalcohols, wherein the ratio of isocyanate groups to isocyanate-reactive groups is about 1 or less, and (b) a second urethane polymer or oligomer comprising the reaction product of (1) one or more diisocyanates, and (2) water wherein about 5 to about 95 mole percent of the isocyanate groups of the diisocyanate are reacted with the water.

16. The method of claim 15 wherein said first polymer or oligomer and said second polymer or oligomer are applied to said substrate simultaneously.

17. The method of claim 15 wherein said first polymer or oligomer and said second polymer or oligomer are applied to said substrate separately.
